(19) United States
(12) Patent Application Publication
(10) Pub. No.: US 2026/0157506 A1
(43) Pub. Date: Jun. 11, 2026

(54) WEARABLE APPARATUS FOR ENCLOSING A WHIP-LIKE DEVICE

(71) Applicant: Ryan McGrath, Mattapoisett, MA (US)

(72) Inventor: Ryan McGrath, Mattapoisett, MA (US)

(21) Appl. No.: 18/974,280

(22) Filed: Dec. 9, 2024

(51) Int. Cl. A45F 3/00; A45C 3/06; A45C 13/30; B68B 11/00

(52) U.S. Cl. CPC A45F 3/005; A45C 3/06; A45C 13/30; B68B 11/00; A45F 2003/003

(57) ABSTRACT

The present disclosure teaches a wearable apparatus for enclosing a whip-like device. The wearable apparatus may be used as a belt or a strap for a bag or purse, having a channel in the middle for enclosing a whip, or a whip-like device such as a charging cord, a pair of wired earphones, or a jump rope. The channel may be formed by sewing a front piece and a back piece together. The whip-like device may have an end cap on a first end, and a loop on a second end. A user may retrieve the whip-like device from the wearable apparatus by pulling the loop. Memory foams may pad the channel. The wearable apparatus may further contain one or more pouches or compartments so that it can be used as a fanny pack.

### TECHNICAL FIELD

The present disclosure relates to the field of wearable technology.

### BACKGROUND

Whips are versatile tools used in various fields, including martial arts, equestrian sports, livestock handling, entertainment, and personal protection. They may also be used as a seat belt cutter and/or a window breaker in case of a car accident. However, their elongated shape and flexible design can make them cumbersome to carry and retrieve. Therefore, developing a wearable apparatus for enclosing a whip would be beneficial. This apparatus could also accommodate other whip-like devices, such as charging cords, wired earphones, and jump ropes.

### SUMMARY

The present disclosure teaches a device, comprising: a wearable apparatus able to be used as a belt or a bag strap, further including: a front piece and a back piece; wherein, both the front piece and the back piece are elongated; wherein, the front piece and the back piece are attached together to form a channel; a whip-like device, enclosed in the channel, further including: an elongated body that is flexible and pliable; an end cap attached to a first end of the elongated body; a loop on a second end of the elongated body; wherein, the whip-like device is able to be retrieved from the wearable apparatus by pulling the loop.

In some embodiments, the front piece and the back piece are made of nylon.

In some embodiments, the nylon is coated.

In some embodiments, the elongated body is made of stainless steel.

In some embodiments, the front piece and the back piece are made of elastic knit.

In some embodiments, the front piece is 2 inch wide.

In some embodiments, the back piece is 3 inch wide.

In some embodiments, the front and back piece are sewn together.

In some embodiments, the front and back piece are sewn together with zigzag stitches.

In some embodiments, the channel is padded.

In some embodiments, the channel is padded with memory foam.

In some embodiments, the wearable apparatus further comprises one or more pouches or compartments.

In some embodiments, the wearable apparatus is used as a fanny pack.

In some embodiments, a protection piece is wrapped around a connecting part of the elongated body and the loop.

In some embodiments, the wearable apparatus is used as a belt.

In some embodiments, two ends of the wearable apparatus are connected by a belt buckle with a prong that is able to fit through a hole on the other end of wearable apparatus.

In some embodiments, two ends of the wearable apparatus are connected by a hook and loop fastener.

In some embodiments, the wearable apparatus is used as a purse or bag strap.

In some embodiments, ends of the wearable apparatus are connected to a purse, bag, or fanny pack using a D-ring and clip mechanism, a buckle system, or looped tabs.

In some embodiments, the loop is formed by bending one end of the elongated body.

### BRIEF DESCRIPTION OF THE DRAWINGS

The present disclosure is further illustrated by way of exemplary embodiments, which are described in detail through the accompanying drawings. These embodiments are not limiting, and in these embodiments, the same numbering indicates the same structure, wherein:

FIG. 1 is an isometric, front-view structural diagram illustrating a wearable apparatus for enclosing a whip-like device, with the whip-liked device enclosed, according to some embodiments of the present disclosure;

FIG. 2 is an isometric front-view structural diagram of the wearable apparatus for enclosing the whip-liked device, with the whip-like device retrieved, according to some embodiments of the present disclosure;

FIGS. 3 and 4 are diagrams illustrating how a user may wear the wearable apparatus, according to some embodiments of the present disclosure.

### DETAILED DESCRIPTION

In order to more clearly illustrate the technical solutions of the embodiments of the present disclosure, the accompanying drawings for the description of the embodiments are described below. Obviously, the accompanying drawings in the following description are only some examples or embodiments of the present disclosure, and it is possible for a person of ordinary skill in the art to apply the present disclosure to other similar scenarios in accordance with these accompanying drawings without creative labor. Unless obviously obtained from the context or the context illustrates otherwise, the same numeral in the drawings refers to the same structure or operation.

It should be understood that the terms “system,” “device,” “unit,” and/or “module” are used herein as a way to distinguish between different components, elements, parts, sections, or assemblies at different levels. However, if other words may achieve the same purpose, the terms may be replaced with alternative expressions.

As indicated in the present disclosure and in the claims, unless the context clearly suggests an exception, the words “one,” “a,” “a kind of,” and/or “the” do not refer specifically to the singular but may also include the plural. In general, the terms “include” and “comprise” suggest only the inclusion of clearly identified steps and elements, which do not constitute an exclusive list, and the method or device may also include other steps or elements.

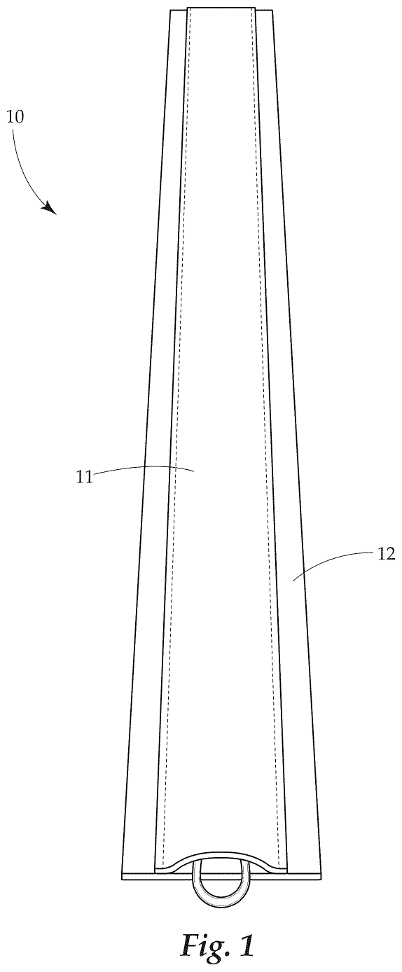

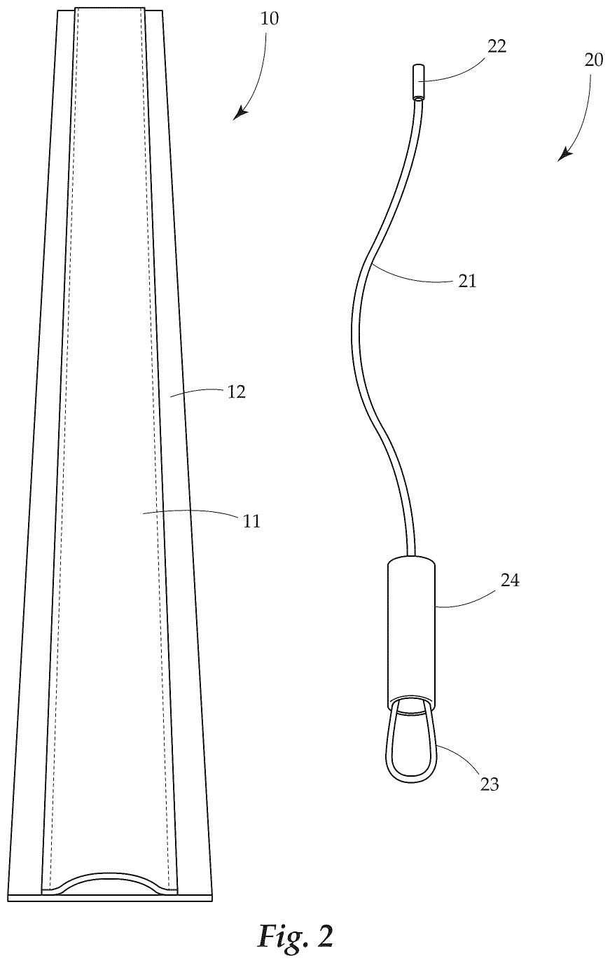

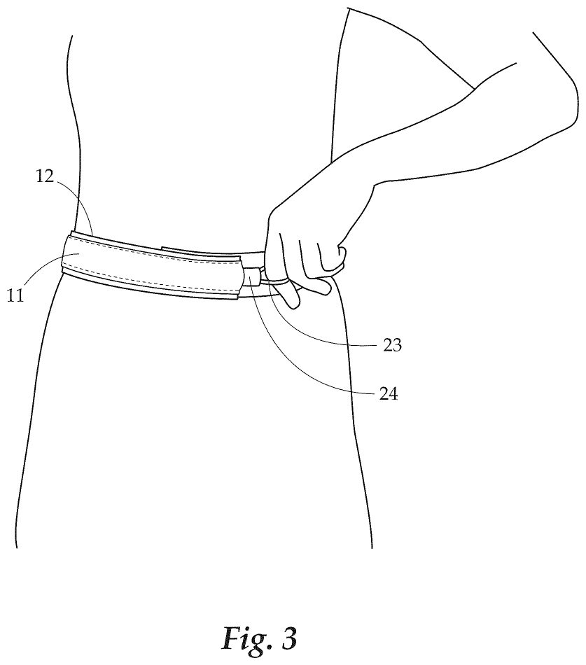

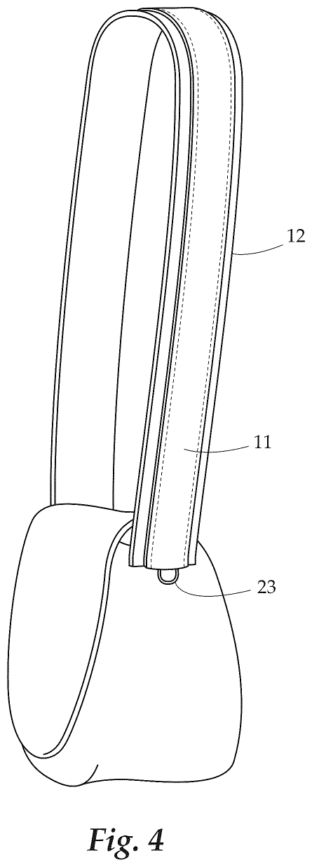

FIG. 1 is an isometric, front-view structural diagram illustrating a wearable apparatus for enclosing a whip-like device, with the whip-liked device enclosed, according to some embodiments of the present disclosure. FIG. 2 is an isometric front-view structural diagram of the wearable apparatus for enclosing the whip-liked device, with the whip-like device retrieved, according to some embodiments of the present disclosure. FIGS. 3 and 4 are diagrams illustrating how a user may wear the wearable apparatus, according to some embodiments of the present disclosure.

As shown in FIG. 1, in some embodiments, the wearable apparatus 10 may include a first piece 11, and a second piece 12. In some embodiments, the wearable apparatus 10 may have an elongated shape. In some embodiments, the wearable apparatus 10 may be rectangular. In some embodiments, ends or corners of the wearable apparatus 10 may be rounded. In some embodiments, dimensions of the wearable apparatus 10 may fit those of a belt, a backpack strap, a penny pack strap, etc. In some embodiments, a length of the wearable apparatus 10 may be adjustable.

In some embodiments, the wearable apparatus 10 may include a front piece 11 and a back piece 12. Both the front piece 11 and the back piece 12 may have an elongated shape. In some embodiments, the front piece 11 and the back piece 12 may be identical in shape and size. In some embodiments, one of the front piece 11 and the back piece 12 may be narrower than the other. In some embodiments, one of the front piece 11 and the back piece 12 may be shorter than the other. In some embodiments, the front piece 11 may have a width of 2 inches, and the back piece 12 may have a width of 3 inches. In some embodiments, the front piece 11 and the back piece 12 may be made of fabric. In some embodiments, the front piece 11 and the back piece 12 may be made of nylon. In some embodiments, the nylon may be coated so that the friction between the whip-like device 20 and the wearable apparatus 10 may be reduced to facilitate smooth retrieval of the whip-like device. In some embodiments, the front piece 11 and the back piece 12 may be made of elastic knit. In some embodiments, the front piece 11 and the back piece 12 may be made of leather.

In some embodiments, the front piece 11 and the back piece 12 may be sewn together along the side edges, forming a channel in the middle. In some embodiments, the front piece 11 and the back piece 12 may be sewn together along the side edges of the narrower of the front and back pieces. In some embodiments, the front piece 11 and the back piece 12 may be sewn together with zigzag stitches. If the wearable apparatus 10 is stretchable (e.g. made of elastic knit), the zigzag stitches may allow expansion and contraction with the wearable apparatus without breaking the threads in the stitches. The zigzag pattern may also have improved strength. In some embodiments, one of the two ends of the wearable apparatus 10 may also be sewn closed. In some embodiments, both ends of the wearable apparatus 10 may be open. In some embodiments, alternatively, the front piece 11 and the back piece 12 may be glued together. In some embodiments, the channel formed by the front piece 11 and the back piece 12 may be padded, making the wearable apparatus more comfortable. The padding also makes the whip-like device 20 better concealed in the wearable apparatus 10, which may be a desirable feature if the whip-like device is used for self-defense. In some embodiments, the channel may be padded with foam or cotton. In some embodiments, the channel may be padded with memory foam. In some embodiments, a zipper, or another form of interlocking strips for secure disclosure, may be attached along a length of the channel so that the whip-like device 20 may be put back in the wearable apparatus 10 more easily after use.

In some embodiments, the two ends of the wearable apparatus 10 may be detachably connected so that the wearable apparatus may be used as a belt. In some embodiments, the two ends of the wearable apparatus 10 may be connected by a belt buckle with a prong that can fit through a hole on the other end of the belt. In some embodiments, the two ends may be joined by a pair of snap buttons. In some embodiments, the two ends may be connected by Chicago screws. In some embodiments, the two ends may be connected by a hook and loop fastener. In some embodiments, the two ends may be tied together in a knot. FIG. 3 illustrates a user wearing the presently disclosed wearable apparatus as a belt.

In some embodiments, the wearable apparatus 10 may look like a standard men's or women's belt. In some embodiments, an extra front piece 11 or an extra back piece 12 may be attached to a standard men's or women's belt to form the presently disclosed wearable apparatus. In some embodiments, the wearable apparatus 10 may be used with an exercise belt.

In some embodiments, the whip-like device 20 may be entirely or mostly concealed in the wearable apparatus 10 when the whip-like device is sheathed.

In some embodiments, the two ends of the wearable apparatus 10 may be detachably connected to a purse, a handbag, or a fanny pack, so that wearable apparatus 10 may be used as a strap. The ends of the wearable apparatus 10 may connect to the purse (or handbag, fanny pack, etc.) using a D-ring and clip mechanism, a buckle system, looped tabs sewn to the purse, etc. FIG. 4 illustrates how the presently disclosed wearable apparatus may function as a carrying strap of a purse.

In some embodiments, alternatively, the wearable apparatus 10 may be an integrated part of clothing or bags. For example, the wearable apparatus 10 may be a built-in belt of a pair of yoga pants, sports pants, jeans, or shorts. For another example, the wearable apparatus 10 may be a built-in strap of a purse, handbag, fanny pack, or backpack.

In some embodiments, one or more pouches or compartments may be attached to the wearable apparatus 10, so that the wearable apparatus may be used as a fanny pack.

In some embodiments, the whip-like device 20 enclosed in the wearable apparatus may be a whip. In some embodiments, the whip-like device 20 may have an elongated body 21, which may be flexible and pliable. In some embodiments, the elongated body 21 may be made of a stainless-steel wire. In some embodiments, the elongated body 21 may be made of a braided metal cable. In some embodiments, the elongated body 21 may be made of nylon, leather, or rubber. In some embodiments, a first end (or a tip) of the whip-like device 20 may include an end cap 22. In some embodiments, the end cap 22 may have an elongated shape and sheath one end of the elongated body 21. In some embodiments, the end cap 22 may be made of metal or other rigid materials. The end cap 22 may serve the dual function of protecting the tip of the whip and enhancing the balance of the whip. The rigid end cap 22 may also facilitate the process of putting the whip-like device 20 back into the wearable apparatus 10 after use. When used in self-defense or equestrian sports, the end cap 22 may move fast and deliver a strong impact, increasing the effectiveness of the whip-like device 20. The end cap 22 may also have various shapes or features to improve the efficacy in self-defense and other applications, including but not limited to a sharp front and/or side edges, one or more small hooks, coiled wire, protrusions or points.

In some embodiments, a second end of the whip-like device 20 may include a loop 23. In some embodiments, the loop 23 may be formed by bending one end of the elongated body 21. In other embodiments, the loop 23 may be made of metal or other rigid materials and may be attached to one end of the elongated body 21. In some embodiments, the loop 23 may stick outside the channel formed by the front piece 11 and the back price 12 when the whip-liked device 20 is sheathed. Hence, a user may retrieve the whip-like device 20 from the wearable device 10 by pulling the loop 23. In some embodiments, the loop 23 may be protected with a protection piece 24. The protection piece 24 may be a piece of material wrapped around the connecting part between the loop 23 and the elongated body 21. In some embodiments, a user may hold the whip-like device 20 by the protection piece 24.

In some embodiments, when the user wears the wearable apparatus 10 as a belt, the loop 23 may be covered by an opposite end of the wearable apparatus, so that the loop may be better concealed.

In some embodiments, the whip-like device 20 may alternatively be a charger, a pair of wired earphones, or even a jump rope. For example, if the whip-like device 20 is a charger, the elongated body 21 may be replaced by a cable, and the end cap 22 and the loop 23 may be replaced by two connectors, such as USB, USB-C, Apple Lightning Connector, MagSafe, etc. If the whip-like device 20 is a pair of wired earphones, the elongated body 21 may be a cable that splits in the middle, and the end cap 22 may be replaced by a pair of earbuds, while the loop 23 may be replaced by a connector/plug. In some embodiments, if the whip-like device 20 is a jump rope, the elongated body 21 may be made of polyvinyl chloride or nylon.

Furthermore, unless explicitly stated in the claims, the use of order, numbers, letters, or other names for processing elements and sequences are not intended to limit the order of the processes and methods of the present disclosure. While various examples have been discussed in the disclosure as currently considered useful embodiments of the invention, it should be understood that such details are provided for illustrative purposes only. The appended claims are not limited to the disclosed embodiments, and instead, the claims are intended to cover all modifications and equivalent combinations within the scope and essence of the embodiments disclosed in the present disclosure. For example, although the described system components may be implemented through a hardware device, they may also be realized solely through a software solution, such as installing the described system on an existing processing or mobile device.

Similarly, it should be noted that, for the sake of simplifying the presentation of embodiments disclosed in the present disclosure and aiding in understanding one or more embodiments of the present disclosure, various features have been sometimes combined into a single embodiment, drawing, or description. However, this manner of disclosure does not imply that the features required by the claims are more than the features mentioned in the claims. In fact, the features of the embodiments are less than all the features of the single embodiment disclosed in the foregoing disclosure.

In some embodiments, numeric values describing the composition and quantity of attributes are used in the description. It should be understood that such numeric values used for describing embodiments may be modified with qualifying terms such as “about,” “approximately” or “generally”. Unless otherwise stated, “about,” “approximately” or “generally” indicates that a variation of ±20% is permitted in the described numbers. Accordingly, in some embodiments, the numerical parameters used in the disclosure and claims are approximations, which can change depending on the desired characteristics of the individual embodiment. In some embodiments, the numerical parameters should take into account a specified number of valid digits and employ a general manner of bit retention. Although the numerical ranges and parameters used in some embodiments of the present disclosure to confirm the breadth of the range are approximations, in specific embodiments, such numerical values are set as precisely as practicable.

With respect to each of the patents, patent applications, publications of patent applications, and other material, such as articles, books, specifications, publications, documents and the like, cited in the present disclosure, the entire contents thereof are hereby incorporated herein by reference. Application history documents that are inconsistent with the contents of the present disclosure or that create conflicts are excluded, as are documents (currently or hereafter appended to the present disclosure) that limit the broadest scope of the claims of the present disclosure. It should be noted that in the event of any inconsistency or conflict between the descriptions, definitions, and/or use of terminology in the materials appended to the present disclosure and the contents described herein, the descriptions, definitions, and/or use of terminology in the present disclosure shall prevail.

In closing, it should be understood that the embodiments described in the present disclosure are used only to illustrate the principles of the embodiments of the present disclosure. Other deformations may also fall within the scope of the present disclosure. Therefore, by way of example and not limitation, alternative configurations of the embodiments disclosed in the present disclosure may be considered consistent with the teachings of the present disclosure. Accordingly, the embodiments described in the present disclosure are not limited to the explicitly introduced and described embodiments in the present disclosure.

What is claimed is:

1. A device, comprising:
a wearable apparatus able to be used as a belt or a bag strap, further including:
a front piece and a back piece;
wherein, both the front piece and the back piece are elongated;
wherein, the front piece and the back piece are attached together to form a channel;
a whip-like device, enclosed in the channel, further including:
an elongated body that is flexible and pliable;
an end cap attached to a first end of the elongated body;
a loop on a second end of the elongated body;
wherein, the whip-like device is able to be retrieved from the wearable apparatus by pulling the loop.

2. The device in claim 1, wherein the front piece and the back piece are made of nylon.

3. The device in claim 2, wherein the nylon is coated.

4. The device in claim 1, wherein the elongated body is made of stainless steel.

5. The device in claim 1, wherein the front piece and the back piece are made of elastic knit.

6. The device in claim 1, wherein the front piece is 2 inch wide.

7. The device in claim 1, wherein the back piece is 3 inch wide.

8. The device in claim 1, wherein the front and back piece are sewn together.

9. The device in claim 1, wherein the front and back piece are sewn together with zigzag stitches.

10. The device in claim 1, wherein the channel is padded.

11. The device in claim 1, wherein the channel is padded with memory foam.

12. The device in claim 1, wherein the wearable apparatus includes one or more pouches or compartments.

13. The device in claim 12, wherein the wearable apparatus is used as a fanny pack.

14. The device in claim 1, wherein a protection piece is wrapped around a connecting part of the elongated body and the loop.

15. The device in claim 1, wherein the wearable apparatus is used as a belt.

16. The device in claim 15, wherein two ends of the wearable apparatus are connected by a belt buckle with a prong that is able to fit through a hole on the other end of wearable apparatus.

17. The device in claim 15, wherein two ends of the wearable apparatus are connected by a hook and loop fastener.

18. The device in claim 1, wherein the wearable apparatus is used as a purse or bag strap.

19. The device in claim 18, wherein ends of the wearable apparatus are connected to a purse, bag, or fanny pack using a D-ring and clip mechanism, a buckle system, or looped tabs.

20. The device in claim 1, wherein the loop is formed by bending one end of the elongated body.
